(19) United States
(12) Patent Application Publication
(10) Pub. No.: US 2022/0044253 A1
(43) Pub. Date: Feb. 10, 2022

(54) SYSTEMS AND TECHNIQUES FOR RECALL INVESTIGATION

(71) Applicant: Ford Global Technologies, LLC, Dearborn, MI (US)

(72) Inventors: Michael Shanton, Allen Park, MI (US); Thayne Hansen, Ypsilanti, MI (US); John Michael Warwood, Northville, MI (US); Agnes Philliben, Canton, MI (US)

(73) Assignee: Ford Global Technologies, LLC, Dearborn, MI (US)

(21) Appl. No.: 16/987,736

(22) Filed: Aug. 7, 2020

(51) Int. Cl. G06Q 30/00; G06Q 30/02; G06F 16/25; G06N 5/04; G06K 9/32

(52) U.S. Cl. CPC G06Q 30/014; G06Q 30/0185; G06K 9/325; G06F 16/258; G06N 5/04; G06Q 30/0201

(57) ABSTRACT

Described herein are methods and systems for determining the disposition of a vehicle having an unresolved recall notice. The computing system receives a first data record from a first vendor and a second data record from a second vendor, the data records including data associated with the vehicle. The computing system applies alignment rules to each data record to normalize the data in each data record. The computing system applies outcome rules to each aligned data record to generate predicted dispositions of the vehicle based on each data record. The computing system applies cross-vendor rules to the predicted dispositions to generate a final disposition of the vehicle, customer, and/or part under recall. The computing system generates a graphical user interface including the final disposition of the vehicle for a user to view.

### BACKGROUND

Automotive manufacturers are responsible for contacting vehicle owners when a recall impacts the owner's vehicle. Regulations requiring such communication are strict for the safety of vehicle owners. However, maintaining information on a vehicle owner may be challenging for many reasons including that owners may freely sell their vehicles and vehicles are destroyed or otherwise removed from the road, and there is no obligation to report such activities to the manufacturer. To comply with regulations, the manufacturer is left with little option than to investigate the whereabouts of a vehicle to ensure the owner is aware of the recall. For these and other reasons there exists a need for a centralized and automated tool to perform recall investigation.

### SUMMARY

In some embodiments, a system is used to determine a disposition of a vehicle having an unresolved recall notice. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for determining the disposition of the vehicle having the unresolved recall notice. The computing system receives a first data record from a first vendor, the first data record including first data associated with the vehicle. The computing system also receives a second data record from a second vendor, the second data record including second data associated with the vehicle. The computing system applies a first set of alignment rules to the first data record to generate an aligned first data record including the first data in a normalized format. The computing system applies a second set of alignment rules to the second data record to generate an aligned second data record including the second data in the normalized format. The computing system applies a first set of source level outcome rules to the aligned first data records to generate a first source level outcome record including a first predicted disposition of the vehicle based on the first data. The computing system applies a second set of source level outcome rules to the aligned second data records to generate a second source level outcome record including a second predicted disposition of the vehicle based on the second data. The computing system applies cross-vendor rules to the first source level outcome record and the second source level outcome record to generate a final disposition of the vehicle based at least in part on the first predicted disposition and the second predicted disposition. The computing system generates a graphical user interface including the source level outcome, the cross-vendor outcome and the final disposition of the vehicle. Other embodiments of this aspect include corresponding computer systems, apparatus, and computer programs recorded on one or more computer storage devices, each configured to perform the actions of the methods.

Implementations may include one or more of the following features. Optionally, the first data record includes at least one of a vehicle identification number of the vehicle or a license plate number associated with the vehicle. In some embodiments, the first data record includes at least one of photographic data, salvage yard data, license plate recognition data, vehicle crash data, state crash data, canvassing data, survey data, used car lot data, or global positioning system location data. In some embodiments, the first data in the normalized format includes at least one of a part classification, a vehicle classification, or a customer classification. In some embodiments, the final disposition includes at least one of an explanation for not resolving the unresolved recall notice, an indication that the unresolved recall notice is resolved, or a plan for resolving the unresolved recall notice. In some embodiments, the explanation for not resolving the unresolved recall notice includes at least one of the vehicle is destroyed, an owner of the vehicle will not cooperate, or the vehicle cannot be located. In some embodiments, the cross-vendor rules include weighting the first predicted disposition and the second predicted disposition based at least in part on an age of the first data record and the second data record, respectively. Implementations of the described techniques may include hardware, a method or process, or computer software on a computer-accessible medium.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components or by a subletter following the reference number (e.g., 205a, 205b, and the like). If only the first reference label is used in the specification, the description is applicable to any one of the similar components having the same first reference label irrespective of the second reference label.

FIG. 1 illustrates a vehicle recall tracking system, according to some embodiments.

FIG. 2 illustrates a vehicle recall investigation VIN attribute tool (RIVAT) system, according to some embodiments.

FIG. 3 illustrates a recall investigation graphical user interface, according to some embodiments.

FIG. 4 illustrates another recall investigation graphical user interface, according to some embodiments.

FIG. 5 illustrates yet another recall investigation graphical user interface, according to some embodiments.

FIG. 6 illustrates a method for performing a vehicle recall investigation disposition determination, according to some embodiments.

FIG. 7 illustrates a block diagram of a vehicle system, according to some embodiments.

FIG. 8 illustrates a block diagram of a computing system, according to some embodiments.

FIG. 9 illustrates a cloud computing system, according to some embodiments.

FIG. 10 illustrates an example vendor level outcome table, according to some embodiments.

### DETAILED DESCRIPTION

Automotive manufacturers issue recalls on components or entire vehicles when component in a vehicle does not perform as expected. An issue with such recalls is ensuring that vehicle owners are made aware of the recall so the associated repair may be performed. Automotive manufacturers assign a unique vehicle identification number (VIN) to each vehicle. The VIN is useful in many ways for identifying or tracking a vehicle. After issue of a recall, the vehicles that have been repaired to address the recall can be tracked using the VIN. After issue of a recall in which notices are published in the media and notices are mailed to the last known address of vehicle owners, there are generally a percentage of vehicles that are unaccounted for. In other words, some vehicle owners do not take their vehicle for the recall repair resulting in vehicles that cannot be accounted for in the recall repair tracking. There are many reasons that a vehicle may not be repaired including that it has been destroyed, the owner is unaware of the recall, the owner is unwilling to comply, and so forth. In many cases, the automotive manufacturers are required to report to regulatory agencies that regulate the automotive industry the number of vehicles that remain unaccounted for with respect to recall repairs. Automotive manufacturers often perform recall investigation to attempt to account for all the vehicles that should undergo recall repair such that an explanation for as many vehicles as possible is provided.

A hurdle for automotive manufacturers to overcome in recall investigation is that the original purchaser of a vehicle may dispose of the vehicle with no obligation to inform the automotive manufacturer of the disposal. For example, the original purchaser may sell the vehicle or destroy the vehicle. The automotive manufacturer is therefore left to search available information to attempt to locate the vehicle. This is made somewhat possible by the association of a VIN with each vehicle. There are numerous sources of information that can be used for performing recall investigation including tollbooth photographs or other license plate recognition data, state registration data, canvassing data, state crash data, salvage yard data, survey data, and so forth. Such information is not uniform and therefore is tedious and difficult to sift through for identifying any given vehicle. Further, data may be outdated.

To address the many difficulties in performing recall investigation, a system is described to obtain information from vendors and automatically generate a disposition (e.g., status or location) of the vehicle that can be used to explain the unresolved recall repair or attempt to address the unresolved recall repair. For example, a disposition indicating the vehicle has been destroyed appropriately explains why the vehicle did not undergo repair. A disposition indicating that the owner and location of the vehicle is unknown despite effort to identify and locate such may be sufficient. A disposition indicating that the owner has been located and contacted and that the repair is now pending may result in resolving the unresolved recall repair.

Information may be obtained from many sources (i.e., vendors) that provide data including survey data, license plate recognition, global positioning system (“GPS”) location data, registration data, and so forth. The data associated with each VIN from each vendor is normalized and analyzed to identify a potential disposition for the vehicle. For example, salvage yard data may indicate the vehicle has been destroyed, license plate recognition data may indicate the vehicle is located in a particular city or state, and so forth. Each vendor's predicted disposition information may be cross-referenced with other vendor predictions to determine a final disposition. Vendor level outcome photographic evidence or notes supporting the final disposition may be reviewed by a person to confirm the determination, provided to the user in a graphical user interface, provided to regulatory agencies for reporting, and so forth.

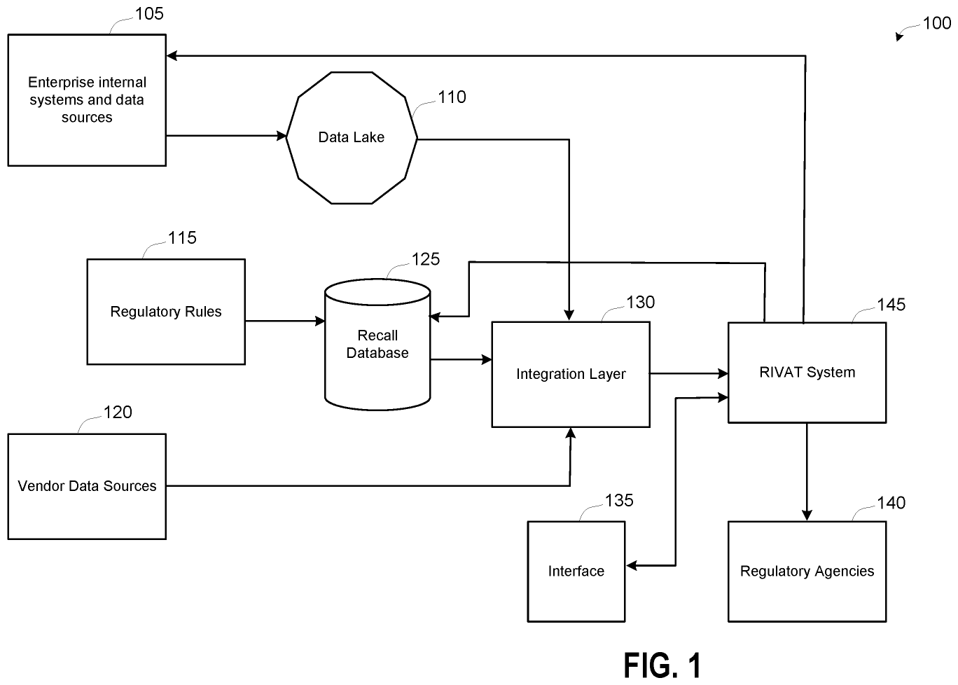

FIG. 1 illustrates a system 100 used for recall investigation. The system 100 may include enterprise internal system and data sources 105, data lake 110, regulatory rules 115, recall database 125, vendor data sources 120, integration layer 130, interface 135, recall investigation VIN attribute tool (RIVAT) system 145, and regulatory agencies 140. While specific components are described in system 100, system 100 may include more or fewer components while still performing the functionality described herein.

Enterprise internal systems and data sources 105 may include systems within the automotive manufacturer enterprise that may include customer information, vehicle information, and the like. Enterprise internal systems which will feed source data into RIVAT will include internal marketing database data which may be maintained outside the recall department and maintains the latest known marketing information associated with the manufacturer's customers. Other internal systems can include repossession systems and Vehicle remarketing systems which may monitor vehicle movement through auctions. Any enterprise system that may provide information about customers, vehicle identification numbers (VIN), recalls, and the like may be included in enterprise internal systems and data sources 105. The data from each of the enterprise internal systems and data sources 105 may be transmitted through the data lake 110 and into the integration layer 130.

Regulatory rules 115 may be a collection or source of rules required to comply with regulations. The regulatory rules 115 may be used to populate recall database 125. The recall database 125 may include all recalls and information on impacted vehicles, latest known owner information for the vehicles, and status of recall repairs. Data from RIVAT system 145 may be fed back into the recall database 125 once processing has occurred on data from the integration layer 130 and the RIVAT system 145.

Vendor data sources 120 include vendors that provide VIN data for recall investigations. The vendors may be the source of the data or may be a vendor that compiles data from other sources. For example, a vendor may be a salvage yard, a state database of crash data, a toll road company that captures photographic images of license plates, a compiling company that captures online used vehicle sale data from one or more other sources of the data and provides a compilation of data, and the like.

Integration layer 130 integrates data from the vendor data sources 120, the recall database 125, and the data lake 110. The integration layer 130 may, in some embodiments, combine the data into appropriate tables of a database, apply logic and codes to normalize all incoming manufacturer data or external vendor data for proper source level outcome alignment, and collect and maintain the history as well as the most recent record of source level VIN data, customer data, and part or recall data. The integration layer 130 may also supply the latest VIN, customer, and/or part level outcomes to the RIVAT system 145 for cross vendor outcome determinations and final outcome determinations. The integration layer 130 or the RIVAT system 145 may, in some embodiments, perform fuzzy logic to match the data from the data lake 110 and the vendor data sources 120, perform natural language processing to extract vehicle specific data, and the like.

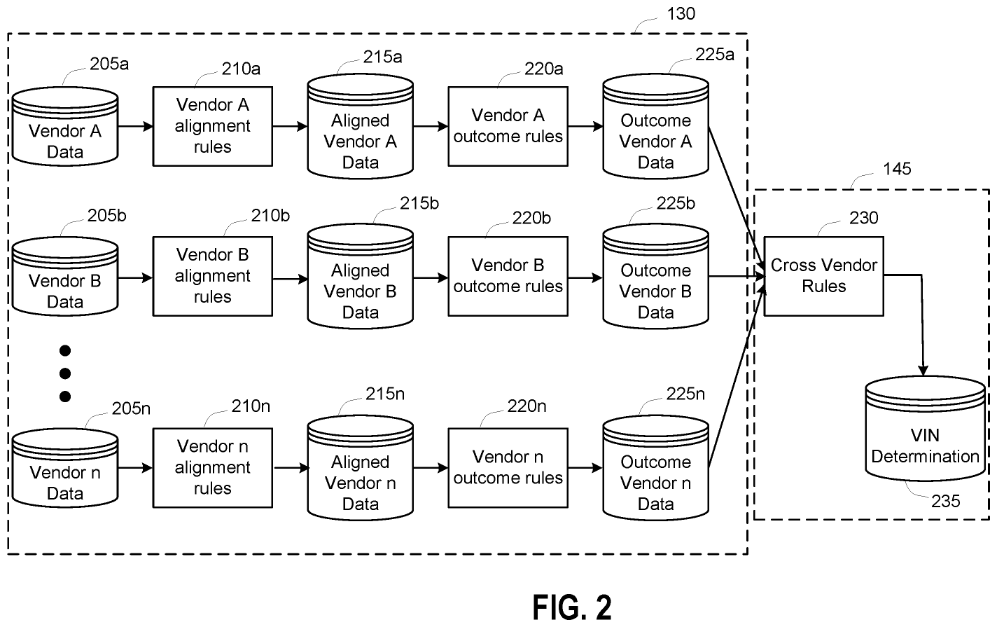

Recall Investigation VIN Attribute Tool (RIVAT) system 145 may be used to perform the automated investigation of the status of a vehicle with respect to an outstanding recall. For example, a vehicle that is subject to a recall may be identified and the RIVAT system 145 may determine based on information from the integration layer 130 whether the vehicle is known to have resolved the recall by undergoing the repair related to the recall. Further, the RIVAT system 145 may identify vehicles that have unresolved recall repairs and attempt to resolve/account for the unresolved recall repair by, for example, explaining why the recall repair is unresolved, identifying information for notifying the current owner of the recall, and so forth. The RIVAT system 145 is described in more detail with respect to FIG. 2.

Regulatory agencies 140 may include any regulatory or compliance agencies, for example the National Highway Traffic Safety Administration (NHTSA), to which the automotive manufacturer may report recall investigation outcome information.

Interface 135 may be a graphical user interface or interface for communication with remote computing systems to provide a graphical user interface on the remote computing system. The graphical user interfaces may allow a user to view or enter data related to the recall investigation of one or more vehicles related to one or more recalls.

In use, the system 100 may be used to compile information, perform recall investigation, and generate and report compliance information with respect to the recall. The enterprise internal systems and data sources 105 may provide internal information including, for example, customer, vehicle, and component information through the data lake 110 to the integration layer 130. The data lake 110 may be used to provide information either by requesting or automatically transmitting (e.g., via batch data load, an application programming interface request, a file transfer protocol request, or the like) the data from data lake 110 to integration layer 130. Vendor data sources 120 may compile information related to vehicles that have been sold by the automotive manufacturer. The data from vendor data sources 120 may have an associated vehicle identification number (VIN) for each vehicle such that the integration layer 130 may uniquely identify each vehicle and associate disparate information about the same vehicle. The vendor data sources 120 may also provide information to integration layer 130 via, for example, file transfer protocol request, application programming interface request, batch data load, or the like. The regulatory rules and other compliance rules may be stored in or provided via regulatory rules 115, which may populate recall database 125 with the regulatory compliance information and rules. The recall database 125 may store data on the regulatory rules as well as compliance information provided by the RIVAT system 145. The recall database 125 may be used by integration layer 130 to generate or identify vehicles that have unresolved recall repairs as well as all associated internal data received through the data lake 110 and vendor data sources 120. After performing the initial data alignment processing as well as source level outcome processing, the integration layer 130 may feed all such data into RIVAT system 145 for cross vendor outcome processing and final outcome processing. The RIVAT system 145 may process the integration layer 130 aligned information from vendor data sources 120, data lake 110, and recall database 125 to generate a disposition of the identified vehicle as discussed in more detail herein. Once a disposition is determined, the RIVAT system 145 may provide the disposition information to the enterprise internal systems and data sources 105, the recall database 125, and the regulatory agencies 140.

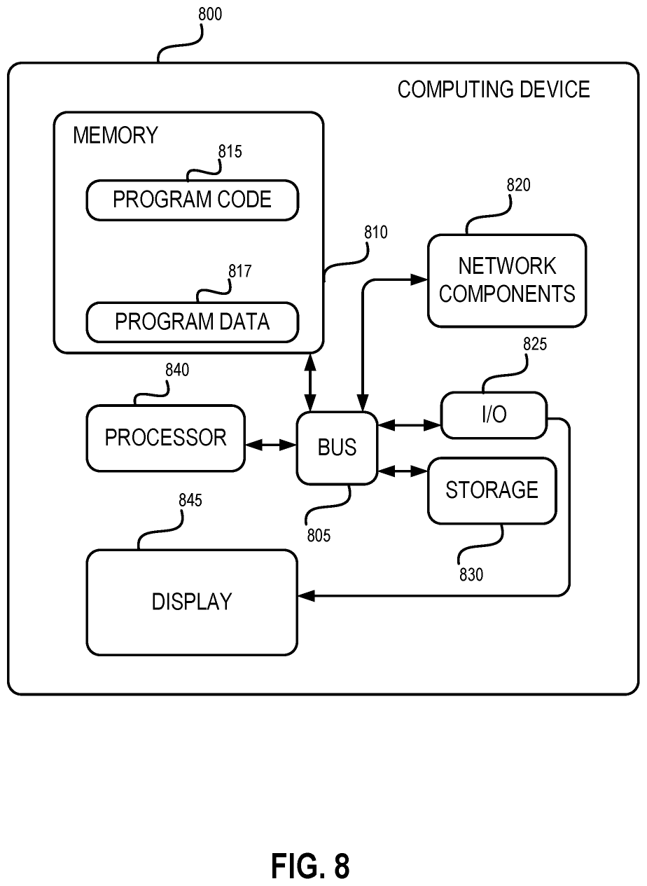

FIG. 2 illustrates further details of integration layer 130 and the RIVAT system 145. The integration layer 130 and the RIVAT system 145 may include one or more computing systems such as, for example, computing device 800 of FIG. 8. The computing systems may include storage for storing data and for storing instructions for processing the stored data using one or more processors. The integration layer 130 and the RIVAT system 145 may include vendor data 205, vendor alignment rules 210, aligned vendor data 215, vendor level outcome rules 220, outcome vendor data 225, cross vendor rules 230, and VIN determinations 235.

Vendor data 205 may be data supplied from vendor data sources 120. Each vendor may provide data in a differing format and may include differing types of information. Each item of information may be associated with a vehicle identification number (VIN) that is a unique number assigned to a vehicle. In some embodiments, license plate data or other data is used to associate the information or data with a vehicle and VIN. There may be any number of vendors as shown by having vendor data 205a, 205b, through 205n. Each vehicle is identified based on the VIN and analyzed as described herein. Vendor data 205 from each vendor may include differing VIN data such that each VIN may not be analyzed based on vendor data 205 from each vendor. For example, VIN 1 may have associated data included in seven of twenty vendor data 205 and VIN 2 may have associated data in fifteen of the twenty vendor data 205. Accordingly, some of the vendors may have data for overlapping VINs. Some vendors may provide similar information from differing geographic locations. For example, each state may provide crash data for the respective state. Toll road companies from differing states and locals may provide vendor data as another example. Vendors and associated data may include salvage yard data, state crash data, state registration data, toll road data, license plate recognition data, survey data, canvassing data, and the like.

Each vendor may have associated vendor alignment rules 210. As shown, vendor 205a has vendor alignment rules 210a. Vendor alignment rules 210a may be specific to Vendor A because the data vendor A provides must be aligned or normalized to compare with and analyze in conjunction with the data from other vendors. Accordingly, there are vendor alignment rules 210a, 210b, through 210n. The integration layer 130 may apply the vendor alignment rules 210 to the vendor data 205 to align the vendor data. The vendor alignment rules 210 may classify the data received from the vendor. In some embodiments, the vendor data may include multiple entries for a given VIN over time, and the vendor alignment rules 210 may include rules to, for example, utilize the most recent entry. The vendor alignment rules 210 may result in, a customer classification, a vehicle classification, and/or a part classification based on the received data for a given VIN. For example, vehicle information received from a salvage yard may indicate that the vehicle has been destroyed. Accordingly, the rules may assign a vehicle classification of scrapped or destroyed. Other classifications of a vehicle may include that the vehicle is located and in use, located and degraded or unserviceable, located as destroyed or scrapped, exported, stolen, or out of service (e.g., due to no registration identified or economic activity during the past several years). Customers may be classified for the vehicle including, for example, that the correct owner and address is identified, the current owner and address information in the integration layer 130 or recall database 125 is incorrect, the correct owner but incorrect address is in the recall database 125 or integration layer 130, the customer is uncooperative, the address on file is undeliverable, the address is inaccessible, and so forth. The part related to the recall may also be classified with respect to the vehicle. For example, the part may be classified as recovered, repaired, replaced, missing, modified, or the like. Further, the data may be classified. For example, the data may be classified as verbal (e.g., from a survey or canvassing), photographic (e.g., from a toll road camera), mail, or based on the source of data. For example, data from a state registration may be of higher quality or more reliable than that of a photograph from a toll road. The classified data is stored as aligned vendor data 215. Each vendor data 205 having had the associated vendor alignment rules 210 applied will result in associated aligned vendor data 215. Accordingly, there will be aligned vendor data 215a, 215b, through 215n.

The vendor level outcome rules 220 may then be applied by the integration layer 130 to the aligned vendor data 215. The vendor level outcome rules 220 may assign dispositions (i.e., vendor level predicted dispositions) to the vehicle based on the vehicle, the customer, and/or the part classifications. For example, a vehicle may be classified as destroyed and the customer may be classified as Incorrect Owner Incorrect Address based on Vendor A Data 205a and Vendor A outcome rules 220a in combination with the contact information of the customer for the VIN of the vehicle stored in the recall database 125. Other vendor dispositions for that VIN may be different depending on the data received from the vendor. Other examples may be that the owner sold the vehicle and no lead is provided; that the owner's address is identified based on, for example, state registration data; that the vehicle has been stolen; that the vehicle has been identified but the owner is unknown; that the part to be repaired is not present in the vehicle and the vehicle is destroyed; and so forth. The vendor level outcome options may be limited to a list of vehicle, customer, and/or part classifications normalized into each vendor data 205 by the vendor alignment rules 210. The vendor level outcome data (i.e., vendor predicted disposition of the VIN) may be stored as outcome vendor data 225. Each vendor may result in a different vehicle, customer, and/or part level outcomes as outcome vendor data 225a, 225b, through 225n.

Integration layer 130 data which is fed into the RIVAT system 145 may have physical evidence, notes, or documents reviewed manually by a person prior to moving into the cross vendor rules 230. These evidence types may include, for example, photos of part recall dispositions (e.g., missing, mitigated, modified), documents and or photos containing export records, police reports of stolen vehicles, or signed refusals from the Customers who do not desire to have the recall repaired. Evidence may also include evidence that an address is undeliverable due to a vacant lot or burned down building, for example. In some embodiments, photographic evidence and other documentation may be analyzed by a neural network that compares and confirms that the photograph or document includes evidence supporting the suggested outcome.

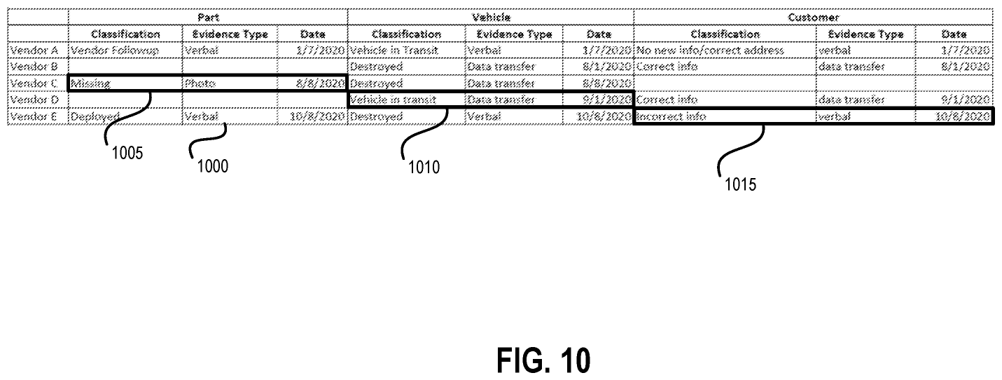

The outcome vendor data 225 may be analyzed collectively for each vehicle. An initial check may be performed to confirm whether the recall repair has been performed on the VIN based on the recall database 125 data. In some embodiments, the automotive manufacturer may solicit vendor data for a VIN and while waiting for the vendors to provide data, the owner of the vehicle may appear for recall repair, which updates the recall database 125 with information indicating the VIN is no longer an unresolved recall repair. At such point, processing for that VIN may stop as the recall repair is resolved. Should the check indicate that the recall repair for the VIN remains unresolved, processing continues. For example, the RIVAT system 145 may apply the cross vendor rules 230 to data from each vendor level outcome data 225 that includes the VIN being analyzed. The cross vendor rules 230 may utilize vehicle, customer/owner, and/or part classification data from each vendor (i.e., the predicted disposition stored as the outcome vendor data 225) to make a final determination of the vehicle, customer, and/or part classifications of the vehicle being analyzed. The cross vendor rules 230 may assign a weight to the predicted determinations based on, for example, the age of the data, the source of the data, and the like. For example, data that was collected months ago may be given a lower weight than data that was collected more recently. As another example, data from sources such as state agencies may be given a higher weight than data from other sources that may be deemed less reliable. Upon applying the cross vendor rules 230, the RIVAT system 145 may determine a final vehicle, customer, and/or part classification of the vehicle. FIG. 10 illustrates an example table 1000 indicating vehicle, customer, and part classifications from Vendors A through E. As shown, the selected part classification 1005 is selected from the data provided by Vendor C after the collective outcome vendor data 225 from each vendor is analyzed. As further shown in the example of table 1000, the selected vehicle classification 1010 is from Vendor D, and the selected customer classification 1015 is from Vendor E. As such, the classification for each of the part, customer, and vehicle may be selected from data from differing vendors. After the final cross vendor vehicle, customer, and/or part dispositions are determined, such as those selected and shown in FIG. 10, a final outcome disposition may be created and include a category and/or subcategory explanation for the unresolved recall repair, an indication that the unresolved recall repair has been resolved, or a plan for resolving the unresolved recall repair. The selected vehicle classification, part classification, customer classification, or some combination thereof may be determinative for the final outcome disposition. In some embodiments, a hierarchical listing of classifications may be used to generate the final disposition. As an example, a selected vehicle classification of destroyed may fall near the top of the hierarchical listing such that any VIN having a vehicle classification of destroyed may be reported as destroyed without further analysis. As another example, a selected part classification of modified, indicating the part has been modified or replaced in the vehicle, may also be reported as a final outcome disposition, but it may fall further down the hierarchical listing than a destroyed vehicle classification because it may be more determinative that the vehicle is no longer on the road than that the part was modified in the vehicle. While examples have been provided throughout this description, any appropriate hierarchical listing and set of classifications may be created for use with RIVAT system 145. The final outcome disposition may also include an associated certainty value to indicate a confidence of RIVAT system 145 that the final outcome disposition is correct.

Once the RIVAT system 145 makes a final outcome determination of the disposition of the vehicle, the final outcome disposition is stored as a VIN determination 235 for the vehicle. In some embodiments, the VIN determination 235 may be used to perform further activities or analysis. For example, an indication that the vehicle owner and address is identified may be used in a plan for resolving the unresolved recall repair. For example, the automotive manufacturer may use the customer information to provide notice to the owner of the recall so the owner may have the repair performed on the vehicle. The final outcome disposition of the vehicle may be provided to any regulatory agencies 140 for compliance. Other information from the RIVAT system 145 including the owner's identified address, for example, may be provided to the recall database 125 and the enterprise internal systems and data sources 105.

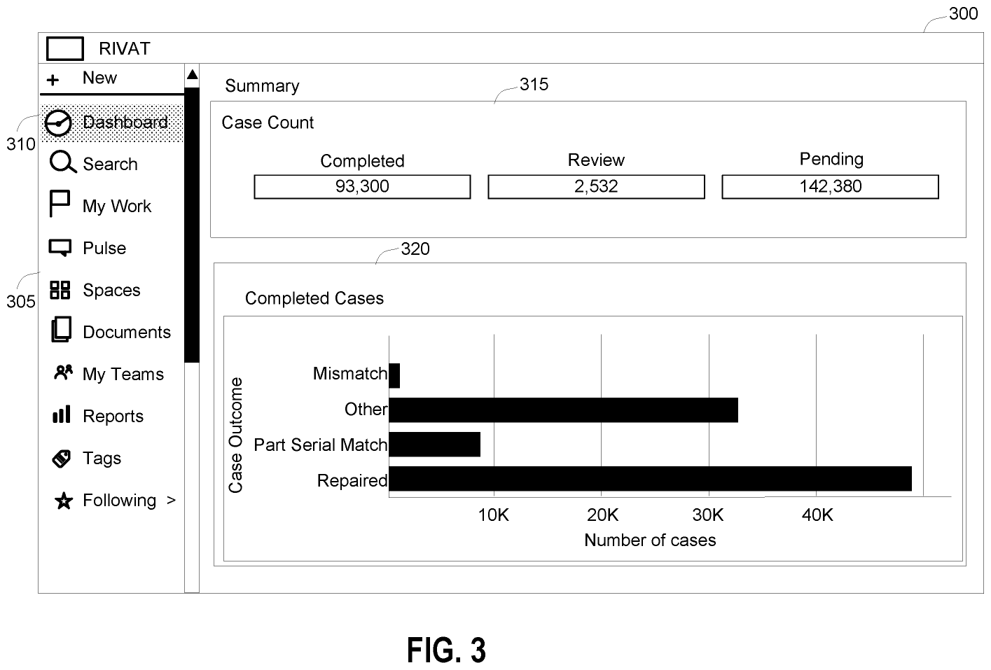

FIG. 3 illustrates an example graphical user interface 300 that may be provided via interface 135. The GUI 300 includes a menu 305 from which the user may choose a view and/or functions. For example, the user has selected dashboard 310 which provides a summary section 315. The summary section 315 includes a count of the number of VINs for a given recall that are accounted, requiring review, or pending. Below the summary an expansion of the completed cases is provided in the completed cases graph 320. The completed cases graph 320 provides a visual summary of the number of cases that have been given final outcome dispositions (e.g., mismatch, repaired, part serial match, and other). The GUI 300 is an exemplary output that may provide any relevant data from RIVAT system 145. For example, the given dispositions shown are exemplary and may be any appropriate disposition available within RIVAT system 145. Further, the menu 305 includes exemplary functionality and viewing options and may include any appropriate functionality and viewing options. Other options may include a search, which may provide an interface for searching for a customer, a VIN, a recall, or any other relevant information provided in the recall investigation. Other options may include an option to view specific work, projects, searches and the like that a given user may have saved. Accordingly, the GUI 300 may be user specific such that user may login to the GUI 300 to store user specific information, configure viewing options, select components for display on the user's dashboard, and so forth.

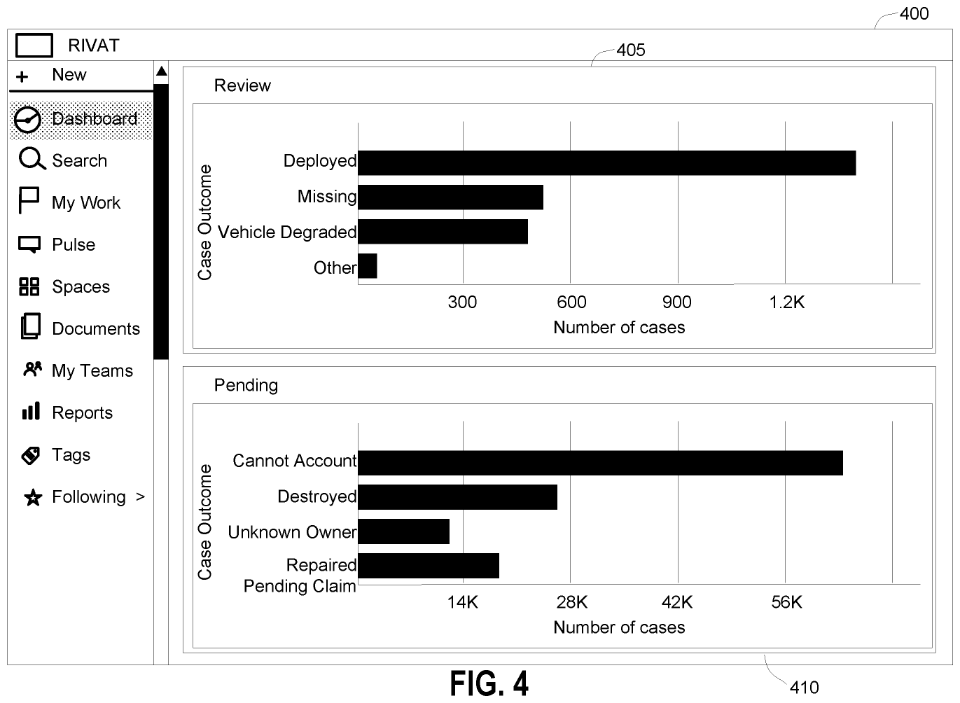

FIG. 4 illustrates a GUI 400 that may be displayed by scrolling the GUI 300 down to show the cases in review graph 405 and the pending cases graph 410. The cases in review graph 405 may provide details of the dispositions of cases that require human review to validate the evidence supporting the disposition. For example, some vehicle data may include notes or physical evidence like a signed refusal or export documentation which would be flagged for human review. The pending cases graph 410 may provide details of the dispositions of cases that are in process with a plan for resolving the unresolved recall repair. For example, in matters where the owner and contact information is identified using the vendor data the cases may remain pending while the owner is contacted for final disposition and resolution.

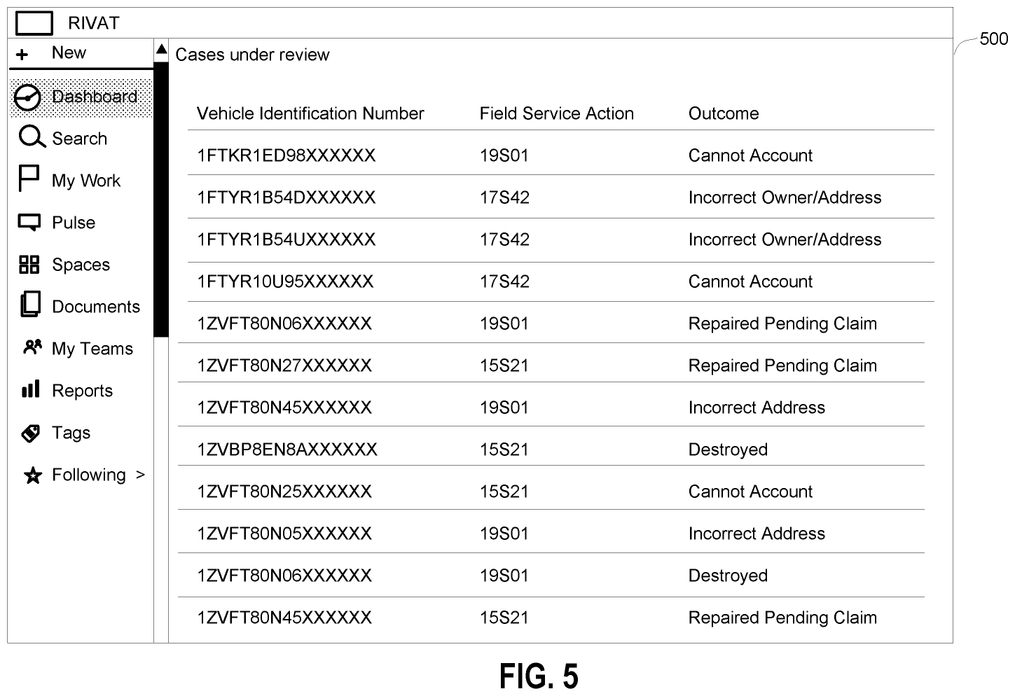

FIG. 5 illustrates an example GUI 500 that may be displayed upon selection of the cases under review graph such that specific details of the individual cases including the recall field service action, the VIN, and the vehicle disposition (i.e., outcome) are provided for each vehicle. For example VIN “1FTKR1ED98XXXXXX” is subject to recall for Field Service Action “19S01” and the current disposition of the vehicle is “Cannot Account,” meaning it cannot be accounted for. A user may select (e.g., click) any line item to obtain specific details about the particular vehicle including accessing the vendor data and further details about the vehicle, the associated owner, and the like. Drill down capability to specifically view details of any data associated with the recall investigation are within the scope of the RIVAT system 145.

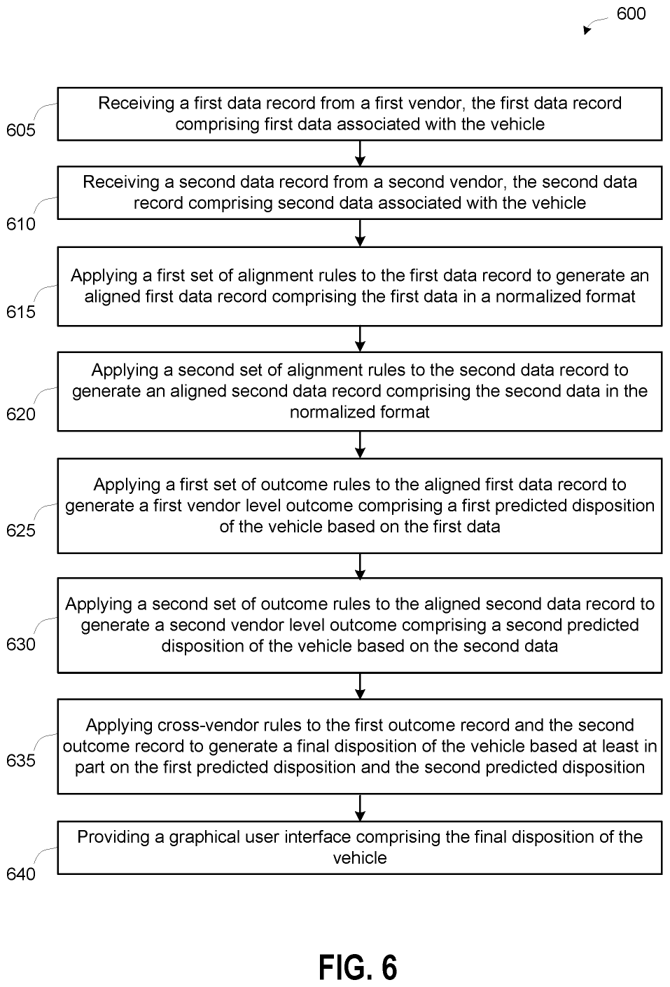

FIG. 6 illustrates an exemplary method 600 for determining a disposition of a vehicle having an unresolved recall repair/notice. The method 600 may be performed by integration layer 130 and RIVAT system 145, for example. The order and number of steps performed in method 600 may be different in some embodiments. The method 600 begins with the integration layer receiving a first data record from a first vendor, the first data record comprising first data associated with the vehicle at step 605. The first data record may be data including the VIN of the vehicle. The first data record may be from, for example, any of vendor data sources 120 described in FIG. 1. For example, the first data record may be a listing of vehicles received at a salvage yard during the month of May, where the vehicles are listed by VIN. The salvage yard may further include data indicating a status of the vehicle, such as whether it is used for parts, destroyed, the parts that remain and have been sold, and so forth.

The integration layer may, at step 610, receive a second data record from a second vendor, the second data record comprising second data associated with the vehicle. The second data record may be from any of the vendor data sources 120 described in FIG. 1. For example, the second data record may be a listing of vehicles that were registered in the state of Nevada during the month of February, where the vehicles are listed by VIN, and the vehicles owner and registration address are further provided in the listing.

At step 615, the system may apply a first set of alignment rules to the first data record to generate an aligned first data record comprising the first data in a normalized format. For example, the alignment rules associated with the salvage yard may classify the vehicle, customer, and/or one or more parts at issue in the recall based on the information provided in the first data record. For example, the vehicle may be classified as destroyed, in transit to a used car dealership, waiting for auction, or the like. The customer/owner may also be classified as unknown or updated with information provided in the first data record, for example. The part at issue in the recall may also be classified as missing, modified, mitigated, or the like.

At step 620, the system may apply a second set of alignment rules to the second data record to generate an aligned second data record comprising the second data in the normalized format. For example, the alignment rules associated with the state registration data may in classify the vehicle, customer, and/or the parts at issue in the recall based on the information provided in the second data record. For example, the vehicle may be classified as located based on the registration data in the second data record. The customer/owner of the vehicle may be classified as located with an address based on the registration data in the second data record. The part may not receive a specific classification based on the registration data.

At step 625, the system may apply a first set of vendor level outcome rules to the aligned first data record to generate a vendor level outcome record comprising a first predicted disposition of the vehicle based on the first data. The first predicted disposition may include vehicle, customer, and/or part classifications based on the first vendor data. For example, the vehicle classification may be destroyed and the part may be missing based on the salvage yard data. Accordingly, vendor level outcome may be that the vehicle is destroyed and the part is missing.

At step 630, the system may apply a second set of vendor level outcome rules to the aligned second data record to generate a second vendor level outcome record comprising a second predicted disposition of the vehicle based on the second data. The second predicted disposition may include vehicle, customer, and/or part classifications based on the second vendor data. For example, the vehicle classification may be located based on the registration data, and the customer name and address may be known. Accordingly, the vendor level outcome may be that the vehicle is In Transit and the Customer Data is Correct Owner Correct Address.

At step 635, the system may apply cross vendor rules to the first vendor level outcome record and the second vendor level outcome record to generate a final outcome disposition of the vehicle based at least in part on the first predicted disposition and the second predicted disposition. For example, the final outcome disposition may be generated based on the vehicle, customer, and/or part classifications provided by the first and the second vendor level outcomes. For example, the first vendor level outcome for the vehicle of destroyed is compared with the second vendor level outcome of In Transit. These dispositions disagree, so each may be assigned a weight and further analyzed. For example the state registration data may be considered a more reliable source than the salvage yard, such that the weight assigned to the second predicted disposition of on the road in Nevada is increased and the weight assigned to the first predicted disposition of destroyed is decreased. However, the age of the data may also impact the weighting. For example, the salvage yard data was a listing from May while the state registration data was a listing from February, both of the same year for the purposes of this example. Accordingly, the weight associated with the salvage yard data first predicted disposition of destroyed is increased and the weight associated with the registration data second predicted disposition of on the road in Nevada is decreased. The weighted data is analyzed and the system may arrive at a final disposition for the vehicle of destroyed based on the newer salvage yard data having a sufficient weight. In some embodiments, a certainty may be assigned to the final disposition based on the analysis. This process may then be repeated for customer classification of vendor level outcomes and part classification of vendor level outcomes. A final outcome disposition may then be published based on the cross vendor vehicle, customer, and part classification outcomes. In some embodiments, the final disposition may provide an explanation as to why the vehicle is not undergoing repair for the recall (e.g., the vehicle is destroyed or exported). In some embodiments, the final outcome disposition may provide a plan for completing the repair (e.g., the customer is located and being contacted). In some embodiments, the final disposition may indicate the recall has been resolved (e.g., the customer repaired or replaced the part prior to the recall or on his own).

At step 640, the system may provide a graphical user interface comprising the final outcome disposition of the vehicle. For example, the GUI 300, 400, and 500 may be provided that a user may use to identify the final outcome (i.e., disposition) of the vehicle.

Note that the example walked through with respect to FIG. 6 is a simplified example for the purposes of explanation. Any number of vendors may provide data, the classifications of vehicles, customers, and parts may be extensive, and the cross vendor outcome weighting and analysis of the vehicle, customer, and part classifications and dispositions may be complex.

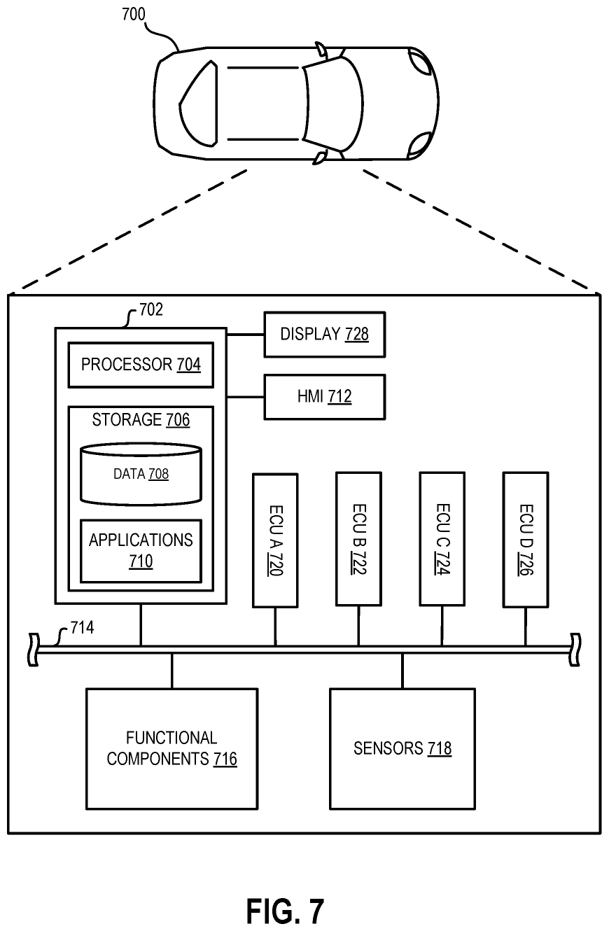

Any suitable computing system or group of computing systems can be used for performing the operations or methods described herein. For example, FIG. 7 illustrates a vehicle system including a computing system 702 as well as multiple ECUs which may perform some or all of the functions described herein. FIG. 8 further depicts an example of a computing device 800 that may be at least a portion of computing system 702.

FIG. 7 illustrates a block diagram of a vehicle system 700, according to some embodiments. The vehicle system 700 may include a computing system 702 configured to communicate over an in-vehicle network 714. The computing system 702 includes a processor 704 and storage 706. While a vehicle system 700 is shown in FIG. 7, the example components as illustrated are not intended to be limiting. Indeed, the vehicle system 700 may have more or fewer components, and additional or alternative components and/or implementations may be used. It should be noted that the use of a vehicle system 700 environment is illustrative, as the components and/or functionality may be utilized in other types of systems such as flight control system in an airplane, or a medical device or industrial machine.

The vehicle system 700 may include various types of automobile, crossover utility vehicle (CUV), sport utility vehicle (SUV), truck, recreational vehicle (RV), boat, plane or other mobile machine for transporting people or goods. In many cases, the vehicle system 700 may be powered by an internal combustion engine. As another possibility, the vehicle system 700 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of the vehicle system 700 may vary, the capabilities of the vehicle system may correspondingly vary. As some other possibilities, vehicle system 700 may have different capabilities with respect to passenger capacity, towing ability and capacity, and storage volume.

The computing system 702 may include a Human Machine Interface (HMI) 712 and a display 728 for user interaction with the computing system 702. An example computing system 702 may be the SYNC™ system provided by FORD MOTOR COMPANY™ of Dearborn, Mich. In some examples the display 728 may include a vehicle infotainment system including one or more displays. The HMI 712 may be configured to support voice command and BLUETOOTH™ interfaces with the driver and driver carry-on devices, receive user input via various buttons or other controls, and provide vehicle status information to a driver or other vehicle system 700 occupants. For instance, the computing system 702 may interface with one or more buttons or other HMI 712 configured to invoke functions on the computing system 702 (e.g., steering wheel audio buttons, a push-to-talk button, instrument panel controls, etc.). The computing system 702 may also drive or otherwise communicate with the display 728 configured to provide visual output to vehicle occupants, e.g., by way of a video controller. In some cases, the display 728 may be a touch screen further configured to receive user touch input via the video controller, while in other cases the display 728 may be a display only, without touch input capabilities. In an example, the display 728 may be a head unit display included in a center console area of the vehicle system 700. In another example, the display 728 may be a screen of a gauge cluster of the vehicle system 700.

The computing system 702 may further include various types of computing apparatus in support of performance of the functions of the computing system 702 described herein. In an example, the computing system 702 may include one or more processors 704 configured to execute computer instructions, and a storage 706 medium on which computer-executable instructions and/or data may be maintained. A computer-readable medium (also referred to as a processor-readable medium or storage 706) includes any non-transitory (e.g., tangible) medium that participates in providing data (e.g., instructions) that may be read by a computer (e.g., by the one or more processors 704). In general, the processor 704 receives instructions and/or data, e.g., from the storage 706, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc. The storage 706 may include divisions for data 708 and applications 710. The data 708 may store information such as databases and other such information. The applications 710 may store the computer-executable instructions or other such instructions executable by the processor 704.

The computing system 702 may be configured to communicate with mobile devices of the vehicle system 700 occupants. The mobile devices may be any of various types of portable computing device, such as cellular phones, tablet computers, smart watches, laptop computers, portable music players, or other devices capable of communication with the computing system 702. As with the computing system 702, the mobile device may include one or more processors configured to execute computer instructions, and a storage medium on which the computer-executable instructions and/or data may be maintained. In some examples, the computing system 702 may include a wireless transceiver (e.g., a BLUETOOTH™ controller, a ZIGBEE™ transceiver, a Wi-Fi transceiver, etc.) configured to communicate with a compatible wireless transceiver of the mobile device. Additionally, or alternately, the computing system 702 may communicate with the mobile device over a wired connection, such as via a USB connection between the mobile device and a Universal Serial Bus (USB) subsystem of the computing system 702.

The computing system 702 may be further configured to communicate with other components of the vehicle system 700 via one or more in-vehicle networks 714. The in-vehicle networks 714 may include one or more of a vehicle controller area network (CAN), an Ethernet network, or a media oriented system transfer (MOST), as some examples. The in-vehicle networks 714 may allow the computing system 702 to communicate with other units of the vehicle system 700, such as ECU A 720, ECU B 722, ECU C 724, and ECU D 726. The ECUs 720, 722, 724, and 726 may include various electrical or electromechanical systems of the vehicle system 700 or control various subsystems of the vehicle system 700. Some non-limiting examples of ECUs include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle system 700); a radio transceiver module configured to communicate with key fobs or other vehicle system 700 devices, a climate control management module configured to provide control and monitoring of heating and cooling system components (e.g., compressor clutch and blower fan control, temperature sensor information, etc.) as well as a transmission control module, a brake control module, a central timing module, a suspension control module, a vehicle modem (which may not be present in some configurations), a global positioning system (GPS) module configured to provide vehicle system 700 location and heading information, and various other vehicle ECUs configured to corporate with the computing system 702. The subsystems controlled by the various ECUs may include functional components 716 of the vehicle system 700 including elements such as the powertrain, engine, brakes, lights, steering components, and the like. Additionally, some or all of the functional components 716 may include sensors 718 as well as additional sensors equipped to the vehicle system 700 for detecting various states, positions, proximity, temperature, and the like of the vehicle system 700 and subsystems thereof. The ECUs 720, 722, 724, 726 may communicate with the computing system 702 as well as the functional components 716 and the sensors 718 over the in-vehicle network 714. While only four ECUs are depicted in FIG. 7, any number (more or fewer) of ECUs may be included in vehicle system 700.

FIG. 8 illustrates a block diagram of an example of a computing device 800. Computing device 800 can be any of the described computers herein including, for example, computing system 702 within the vehicle system 700 of FIG. 7 as well as ECUs 720, 722, 724, 726. The computing device 800 can be or include, for example, an integrated computer, a laptop computer, desktop computer, tablet, server, or other electronic device.

The computing device 800 can include a processor 840 interfaced with other hardware via a bus 805. A memory 810, which can include any suitable tangible (and non-transitory) computer readable medium, such as RAM, ROM, EEPROM, or the like, can embody program components (e.g., program code 815) that configure operation of the computing device 800. Memory 810 can store the program code 815, program data 817, or both. In some examples, the computing device 800 can include input/output (“I/O”) interface components 825 (e.g., for interfacing with a display 845, keyboard, mouse, and the like) and additional storage 830.

The computing device 800 executes program code 815 that configures the processor 840 to perform one or more of the operations described herein. Examples of the program code 815 include, in various embodiments logic flowchart described with respect to FIG. 6 above. The program code 815 may be resident in the memory 810 or any suitable computer-readable medium and may be executed by the processor 840 or any other suitable processor.

The computing device 800 may generate or receive program data 817 by virtue of executing the program code 815. For example, sensor data, trip counter, authenticated messages, trip flags, and other data described herein are all examples of program data 817 that may be used by the computing device 800 during execution of the program code 815.

The computing device 800 can include network components 820. Network components 820 can represent one or more of any components that facilitate a network connection. In some examples, the network components 820 can facilitate a wireless connection and include wireless interfaces such as IEEE 802.11, BLUETOOTH™, or radio interfaces for accessing cellular telephone networks (e.g., a transceiver/antenna for accessing CDMA, GSM, UMTS, or other mobile communications network). In other examples, the network components 820 can be wired and can include interfaces such as Ethernet, USB, or IEEE 1394.

Although FIG. 8 depicts a computing device 800 with a processor 840, the system can include any number of computing devices 800 and any number of processor 840. For example, multiple computing devices 800 or multiple processor 840 can be distributed over a wired or wireless network (e.g., a Wide Area Network, Local Area Network, or the Internet). The multiple computing devices 800 or multiple processor 840 can perform any of the steps of the present disclosure individually or in coordination with one another.

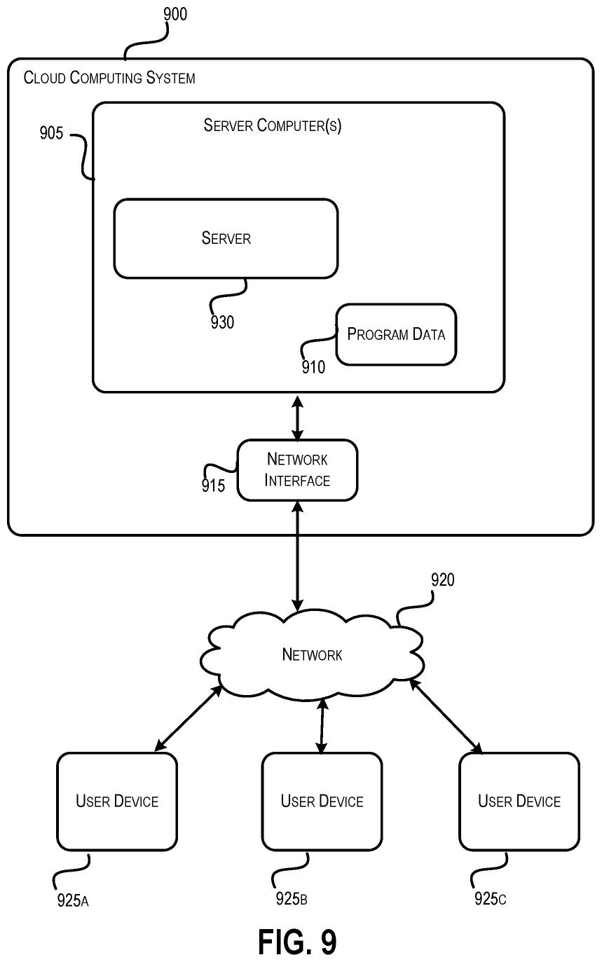

In some embodiments, the functionality provided by the computing device 800 may be offered as cloud services by a cloud service provider. For example, FIG. 9 depicts an example of a cloud computing system 900 offering an intelligence service that can be used by a number of user subscribers using user devices 925a, 925b, and 925c across a data network 920. User devices 925a, 925b, and 925c could be examples of a vehicle system 700 described above. In the example, the intelligence service may be offered under a Software as a Service (SaaS) model. One or more users may subscribe to the intelligence service, and the cloud computing system performs the processing to provide the intelligence service to subscribers. The cloud computing system may include one or more remote server computers 905.

The remote server computers 905 include any suitable non-transitory computer-readable medium for storing program code (e.g., server 930) and program data 910, or both, which is used by the cloud computing system 900 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 905 can include volatile memory, non-volatile memory, or a combination thereof.

One or more of the server computers 905 execute the program data 910 that configures one or more processors of the server computers 905 to perform one or more of the operations that determine locations for interactive elements and operate the adaptive rule-based system. As depicted in the embodiment in FIG. 9, the one or more server computers 905 provide the services to perform the adaptive rule-based system via the server 930. Any other suitable systems or subsystems that perform one or more operations described herein (e.g., one or more development systems for configuring an interactive user interface) can also be implemented by the cloud computing system 900.

In certain embodiments, the cloud computing system 900 may implement the services by executing program code and/or using program data 910, which may be resident in a memory device of the server computers 905 or any suitable computer-readable medium and may be executed by the processors of the server computers 905 or any other suitable processor.

In some embodiments, the program data 910 includes one or more datasets and models described herein. Examples of these datasets include dealership data, classification data, etc. In some embodiments, one or more of data sets, models, and functions are stored in the same memory device. In additional or alternative embodiments, one or more of the programs, data sets, models, and functions described herein are stored in different memory devices accessible via the data network 920.

The cloud computing system 900 also includes a network interface device 915 that enable communications to and from cloud computing system 900. In certain embodiments, the network interface device 915 includes any device or group of devices suitable for establishing a wired or wireless data connection to the data networks 920. Non-limiting examples of the network interface device 915 include an Ethernet network adapter, a modem, and/or the like. The server 930 is able to communicate with the user devices 925a, 925b, and 925c via the data network 920 using the network interface device 915.

While the present subject matter has been described in detail with respect to specific aspects thereof, it will be appreciated that those skilled in the art, upon attaining an understanding of the foregoing, may readily produce alterations to, variations of, and equivalents to such aspects. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Aspects of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

What is claimed is:

1. A computer-implemented method for determining a disposition of a vehicle having an unresolved recall notice, the method comprising:
receiving a first data record from a first vendor, the first data record comprising first data associated with the vehicle;
receiving a second data record from a second vendor, the second data record comprising second data associated with the vehicle;
applying a first set of alignment rules to the first data record to generate an aligned first data record comprising the first data in a normalized format;
applying a second set of alignment rules to the second data record to generate an aligned second data record comprising the second data in the normalized format;
applying a first set of outcome rules to the aligned first data record to generate a first outcome record comprising a first predicted disposition of the vehicle based on the first data;
applying a second set of outcome rules to the aligned second data record to generate a second outcome record comprising a second predicted disposition of the vehicle based on the second data;
applying cross-vendor rules to the first outcome record and the second outcome record to generate a final disposition of the vehicle based at least in part on the first predicted disposition and the second predicted disposition; and
providing a graphical user interface comprising the final disposition of the vehicle.

2. The computer-implemented method of claim 1, wherein the first data record comprises at least one of a vehicle identification number of the vehicle or a license plate number associated with the vehicle.

3. The computer-implemented method of claim 1, wherein the first data record comprises at least one of photographic data, salvage yard data, license plate recognition data, vehicle crash data, state crash data, canvassing data, survey data, used car lot data, or global positioning system location data.

4. The computer-implemented method of claim 1, wherein the first data in the normalized format comprises at least one of a vehicle classification or a customer classification.

5. The computer-implemented method of claim 1, wherein the final disposition comprises at least one of an explanation for not resolving the unresolved recall notice, an indication that the unresolved recall notice is resolved, or a plan for resolving the unresolved recall notice.

6. The computer-implemented method of claim 5, wherein the explanation for not resolving the unresolved recall notice comprises at least one of the vehicle is destroyed, an owner of the vehicle will not cooperate, or the vehicle cannot be located.

7. The computer-implemented method of claim 1, wherein the cross-vendor rules comprise weighting the first predicted disposition and the second predicted disposition based at least in part on an age of the first data record and the second data record, respectively.

8. A system for determining a disposition of a vehicle having an unresolved recall notice, the system comprising:
one or more processors; and
a memory device having stored thereon instructions that, upon execution by the one or more processors, cause the one or more processors to:
receive a first data record from a first vendor, the first data record comprising first data associated with the vehicle;
receive a second data record from a second vendor, the second data record comprising second data associated with the vehicle;
apply a first set of alignment rules to the first data record to generate an aligned first data record comprising the first data in a normalized format;
apply a second set of alignment rules to the second data record to generate an aligned second data record comprising the second data in the normalized format;
apply a first set of outcome rules to the aligned first data record to generate a first outcome record comprising a first predicted disposition of the vehicle based on the first data;
apply a second set of outcome rules to the aligned second data record to generate a second outcome record comprising a second predicted disposition of the vehicle based on the second data;
apply cross-vendor rules to the first outcome record and the second outcome record to generate a final disposition of the vehicle based at least in part on the first predicted disposition and the second predicted disposition; and
generate a graphical user interface comprising the final disposition of the vehicle.

9. The system of claim 8, wherein the first data record comprises at least one of a vehicle identification number of the vehicle or a license plate number associated with the vehicle.

10. The system of claim 8, wherein the first data record comprises at least one of photographic data, salvage yard data, license plate recognition data, vehicle crash data, state crash data, canvassing data, survey data, used car lot data, or global positioning system location data.

11. The system of claim 8, wherein the first data in the normalized format comprises at least one of a vehicle classification or a customer classification.

12. The system of claim 8, wherein the final disposition comprises at least one of an explanation for not resolving the unresolved recall notice, an indication that the unresolved recall notice is resolved, or a plan for resolving the unresolved recall notice.

13. The system of claim 12, wherein the explanation for not resolving the unresolved recall notice comprises at least one of the vehicle is destroyed, an owner of the vehicle will not cooperate, or the vehicle cannot be located.

14. The system of claim 8, wherein the cross-vendor rules comprise weighting the first predicted disposition and the second predicted disposition based at least in part on an age of the first data record and the second data record, respectively.

15. A computer-readable memory having stored thereon instructions for determining a disposition of a vehicle having an unresolved recall notice that, upon execution by one or more processors, cause the one or more processors to:
receive a first data record from a first vendor, the first data record comprising first data associated with the vehicle;
receive a second data record from a second vendor, the second data record comprising second data associated with the vehicle;
apply a first set of alignment rules to the first data record to generate an aligned first data record comprising the first data in a normalized format;
apply a second set of alignment rules to the second data record to generate an aligned second data record comprising the second data in the normalized format;
apply a first set of outcome rules to the aligned first data record to generate a first outcome record comprising a first predicted disposition of the vehicle based on the first data;
apply a second set of outcome rules to the aligned second data record to generate a second outcome record comprising a second predicted disposition of the vehicle based on the second data;
apply cross-vendor rules to the first outcome record and the second outcome record to generate a final disposition of the vehicle based at least in part on the first predicted disposition and the second predicted disposition; and
generate a graphical user interface comprising the final disposition of the vehicle.

16. The computer-readable memory of claim 15, wherein the first data record comprises at least one of a vehicle identification number of the vehicle or a license plate number associated with the vehicle.

17. The computer-readable memory of claim 15, wherein the first data record comprises at least one of photographic data, salvage yard data, license plate recognition data, vehicle crash data, state crash data, canvassing data, survey data, used car lot data, or global positioning system location data.

18. The computer-readable memory of claim 15, wherein the first data in the normalized format comprises at least one of a part classification, a vehicle classification, or a customer classification.

19. The computer-readable memory of claim 15, wherein the final disposition comprises at least one of an explanation for not resolving the unresolved recall notice, an indication that the unresolved recall notice is resolved, or a plan for resolving the unresolved recall notice, and wherein the explanation for not resolving the unresolved recall notice comprises at least one of the vehicle is destroyed, an owner of the vehicle will not cooperate, or the vehicle cannot be located.

20. The computer-readable memory of claim 15, wherein the cross-vendor rules comprise weighting the first predicted disposition and the second predicted disposition based at least in part on an age of the first data record and the second data record, respectively.
